(19) United States
(12) Patent Application Publication
(10) Pub. No.: US 2013/0082646 A1
(43) Pub. Date: Apr. 4, 2013

(54) Side Charging Inductor

(71) Applicants: Allan K. Yeung, Seattle, WA (US); Justin A. Coppin, Windsor, CO (US)

(72) Inventors: Allan K. Yeung, Seattle, WA (US); Justin A. Coppin, Windsor, CO (US)

(73) Assignee: Microsoft Corporation, Redmond, WA (US)

(21) Appl. No.: 13/249,875

(22) Filed: Sep. 30, 2011

(51) Int. Cl. H02J 7/00

(52) U.S. Cl. 320/108

(57) ABSTRACT

Techniques involving a side charging inductor and associated functionality are described. In one or more implementations, the techniques describe a mobile device that includes a housing with a first side and a second side that are not substantially parallel to one another. The first side may include an exposed face upon which the mobile device is configured to rest on a surface, and the second side may include a coil for charging a battery of the mobile device using induction.

### BACKGROUND

Designs for computing devices are ever changing. However, these designs are often limited by hardware components which enable device functionality. For example, hardware components may affect certain aspects of a design, such as structure, visual quality, and/or robustness.

In one example, a device component may include a coil for charging a battery in a mobile device by using induction. Conventional induction coil designs for mobile devices used charging coils located on a front or back of the mobile devices. However, these conventional techniques may limit the effectiveness of the induction because a metal backplate or frontplate may interfere with the induction and thereby reduce efficiency. On the other hand, a non-metal backplate or frontplate may compromise visual quality and/or mechanical robustness of the mobile device, resulting in reduced user satisfaction.

### SUMMARY

Techniques involving side charging inductors and other functionality are described. In one or more implementations, a housing for a mobile device includes a first side and a second side that are not substantially parallel to one another. The first side may include an exposed face upon which the mobile device is configured to rest on a surface. The second side may include a coil configured to charge a battery of the mobile device using induction.

In other embodiments, a side of the mobile device may be located proximate a charging device to substantially align a first coil positioned on the side of the mobile device with a second coil in the charging device. The side of the mobile device may also be substantially perpendicular to a resting side of the mobile device. Additionally, the resting side may include an exposed face upon which the mobile device may rest on a surface. The first coil may also be electrically coupled to a battery of the mobile device. In addition, the battery of the mobile device may be charged through induction between the first and second coils.

In other embodiments, a charging device includes a housing and an inductive coil that is positioned in the housing. The inductive coil may induce a current in a coil of a mobile device to charge a battery of the mobile device. In addition, the inductive coil may be positioned within the housing as substantially perpendicular to a plane defined by an outer surface of a display device of the mobile device when the mobile device is positioned proximal to the housing to enable inductive charging using the coils.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation of a side charging inductor in accordance with one or more embodiments.

FIG. 2 illustrates an example implementation of a side charging inductor in accordance with one or more embodiments.

FIG. 3 illustrates an example technique for induction charging of a mobile device in accordance with one or more embodiments.

FIG. 4 illustrates various components of an example device that can be implemented as any type of portable and/or computer device as described with reference to FIGS. 1-3 to implement embodiments of the side charging inductor described herein.

### DETAILED DESCRIPTION

### Overview

Conventional techniques that were used for induction charging of a mobile device's battery may limit certain aspects of the mobile device, such as visual quality, mechanical robustness, and/or induction efficiency, at least by affecting the mobile device's internal and/or external structure. For example, traditional induction coils are located on a frontplate or backplate of the mobile device. Often, the frontplate or backplate is formed of a metal, which interferes with the induction and thereby reduces efficiency. This interference may force a mobile device to be formed substantially from non-metal materials. However, for thin devices, non-metal materials may lack robustness, durability, and/or “feel” desired by consumers and designers of the mobile device. Therefore, these conventional techniques may result in decreased user satisfaction regarding sturdiness, durability, and/or visual quality of a mobile device, as well as the induction efficiency.

Side charging inductors are described. In the following discussion, a variety of different implementations are described that involve side charging inductors to enable induction charging of a battery of a mobile device. For example, in one or more implementations, a mobile device may include a housing with an induction coil positioned on a side of the housing where the side is substantially perpendicular to a frontplate or backplate of the mobile device. Use of a side charging inductor may reduce non-metal areas implemented in the housing, thereby providing additional options to designers of the device. Further discussion of this and other implementations that involve use of side charging inductors may be found in the following sections.

In the following discussion, an example environment is first described that is operable to employ techniques using side charging inductors described herein. Example illustrations of side charging inductors and procedures involving the side charging inductors are then described, which may be employed in the example environment as well as in other environments. Accordingly, the example environment is not limited to performing the example procedures. Likewise, the example procedures are not limited to implementation in the example environment.

### Example Environment

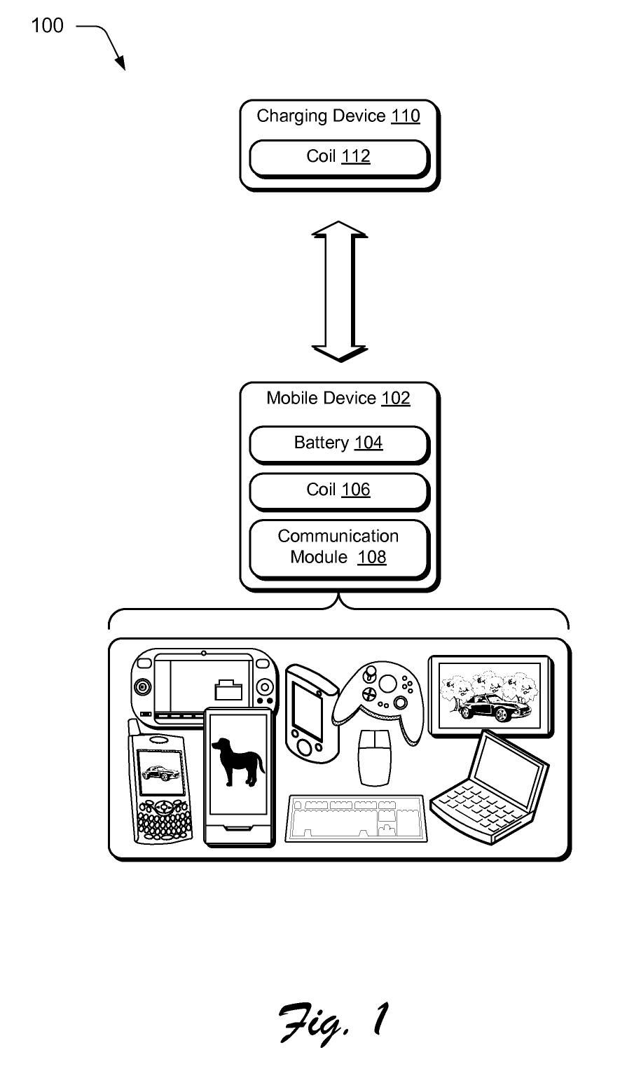

FIG. 1 is an illustration of an environment 100 in an example implementation that is operable to employ techniques for side charging inductors. The illustrated environment 100 includes an example of a mobile device 102 that includes a battery 104 and coil 106, which are electrically coupled to each other. The mobile device 102 also includes a communication module 108. In addition, the illustrated environment 100 includes a charging device 110 that includes a coil 112 for inducing a current in the coil 106 of the mobile device 102.

The mobile device 102 may assume a variety of different configurations. For instance, the mobile device 102 may include mobile phones, portable music players, game devices, personal digital assistants (PDA), mobile computers, digital cameras, and so on. The mobile device 102 may also include personal computers, laptop computers, tablets, netbooks, and so on. The mobile device 102 may also include input devices such as game controllers, keyboards, a computer mouse, and so on. Thus, the techniques described herein may be supported by these various configurations of the mobile device 102 and are not limited to the specific examples described in the following sections.

The battery 104 may assume a variety of configurations. In one or more embodiments, the battery 104 may include a rechargeable battery. By way of example and not limitation, some examples of rechargeable batteries include alkaline, lithium-ion, nickel-meat hydride, nickel-cadmium, lithium-ion polymer, and so on. In one or more embodiments, the battery 104 is configured to power the mobile device 102 and/or one or more components of the mobile device 102, e.g., hardware of the device.

The coil 106 is representative of functionality associated with induction (e.g., electromagnetic induction which involves production of a current across a conductor in a magnetic field). The coil 106 may assume a variety of different configurations. In one or more embodiments, the coil 106 may be constructed as a coil of conducting material (e.g., metal such as copper wire) wrapped around a core of air or a core of ferromagnetic or ferrimagnetic material. Other configurations are also contemplated.

Through induction, the coil 106 may charge the battery 104. For example, the coil 106 may be electrically coupled to the battery 104. Current generated in the coil 106 through induction may be transferred to the battery 104 to charge the battery 104.

The communication module 108 is representative of functionality associated with communicating to a user an indication that the battery 104 is charging. The indication may assume a variety of different configurations. In one or more embodiments, during induction charging of the battery 104, the indication may include a notification displayed on a display device of the mobile device 102 to notify the user that the battery 104 is receiving a charge. In one or more embodiments, the indication may include turning on or changing color of a light, an audible sound playing, or occurrence of a tactile response. These examples discussed are not intended to be limiting and a variety of other examples are also contemplated.

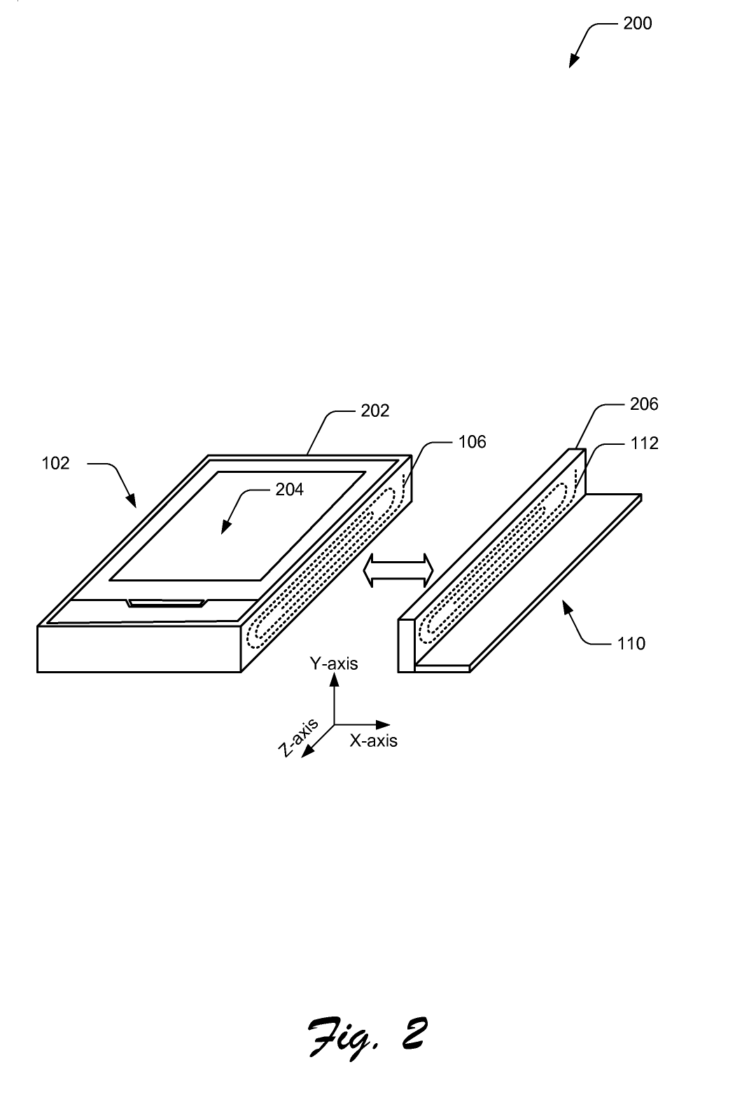

The charging device 110 may assume a variety of different configurations. In one or more embodiments, the charging device 110 is structured to house a coil 112. Coil 112 represents functionality associated with electromagnetic induction, which in this instance is charging the mobile device 102. For example, coil 112 may act as an inductor to transfer energy to coil 106 in the mobile device 102 through induction for charging the battery 104 of the mobile device 102. Examples of configurations of the mobile device 102 and the charging device 110 may be found beginning in relation to FIG. 2.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the side charging inductor described below are platform-independent, meaning that the techniques may be implemented on a variety of commercial computing platforms having a variety of processors.

FIG. 2 illustrates an example implementation 200 that is operable to employ a side charging inductor. For example, the example implementation 200 includes a mobile device 202 with a housing 202. In embodiments, the housing 202 may form the supporting structure of the mobile device 102 referred to in FIG. 1. Alternatively, the housing 202 may be a component of the mobile device 102 referred to in FIG. 1.

In one or more embodiments, the housing 202 may include multiple sides. For example, the housing 202 may include a front 204 and an opposing back side. In an embodiment, the front 204 may include a display screen. In addition, the back side may include a backplate. In embodiments, the front 204 and/or back side may be substantially parallel to a display screen of the mobile device 102.

The housing 202 may also include a resting side that has an exposed face upon which the mobile device 102 is configured to rest on a surface. In one or more embodiments, the front 204 and/or back side may be used as the resting side. In addition, the housing includes one or more other sides including exposed surfaces that are substantially perpendicular to the exposed surfaces of the front 204 and/or back side. In embodiments, at least one of the other sides includes a smaller exposed area that than an exposed area of the front 204. The smaller exposed area of the at least one side may also be smaller than an exposed area of the resting side. In embodiments, one of these other sides may include coil 106, referred to in FIG. 1, as part of the side charging inductor for induction charging of the battery 104.

The housing 202 may be formed substantially from metal for durability and robustness. Traditionally, inductive coils were implemented in the back side of devices, which prevented the use of metal because conductive materials would interfere with the induction. In the example implementation 200, however, the coil 106 is disposed on a side of the housing 202 that is substantially perpendicular to the resting side (e.g., front or back side). With the coil 106 on the side, the front and back side may be formed substantially from metal without interfering with the induction. In addition, one or more of the other sides that do not include the coil 106 may also be formed substantially from metal without interfering with the induction.

By forming the housing 202 substantially from metal, the mobile device 102 may include the durability and robustness desired by designers and consumers of the mobile device 102. In addition, designers may have fewer limitations in constructing thin, robust components of the housing 202 that have the visual quality desired by consumers of the mobile device 102. Also, a variety of components, such as backplates and/or frontplates, may be replaceable without compromising the induction. In embodiments, accessories such as covers or protective cases may be coupled to the housing 202 of the device, and may be less likely to interfere with the induction if the accessory exposes the side of the housing 202 that includes the coil 106. The accessory may be coupled securely to the housing 202 by a variety of configurations, and may firmly protect a majority of the device.

The example implementation 200 also includes a charging device 110 with a housing 206 that includes coil 112. In one or more embodiments, coil 112 is positioned within the housing 206 of the charging device 110 such that the coil 112 is substantially perpendicular to a plane defined by a display device of the mobile device 102 when the mobile device 102 is positioned proximal to the housing 206 of the charging device 110. In alternative embodiments, when the coil 106 of the mobile device 102 is positioned proximal to the coil 112 of the charging device 110, the coil 112 may be substantially perpendicular to a plane defined by the resting side of the mobile device 102.

In one or more embodiments, the coil 112 in the charging device 110 may be substantially the same size as that of the coil 106 in the mobile device 102. In alternative embodiments, the coil 112 may be a different size than coil 106, such as larger or smaller than coil 106 of the mobile device 102. In one or more implementations, charging device 110 may be constructed of sufficient size to charge multiple mobile devices 102. In implementations, charging device 110 may include multiple coils 112 for charging one or more batteries of each of the multiple mobile devices.

In embodiments, aligning the mobile device 102 in each of three directional axes of three-dimensional space may improve efficiency of the induction. In embodiments, the side charging inductor may facilitate easy alignment for a user by minimizing a number of axes for the user to align to a single axis. For instance, the x-axis may determine a distance between the coil 106 of the mobile device 102 and the coil 112 of the charging device 110. Locating the mobile device 102 proximal to the charging device 110 to minimize the distance between coils may improve the energy transfer from the charging device 110 to the mobile device 102. In addition, because the mobile device 102 and the charging device 110 may rest on a same surface, such as a countertop or table, the mobile device 102 is automatically substantially aligned with the charging device 110 in the y-axis, as referred to in FIG. 2. Accordingly, a single axis, e.g., the z-axis, remains to be aligned in order to maximize induction efficiency based on coil alignment. This may allow a user to align the coils more easily than in traditional techniques, in which users aligned devices in two axis (e.g., x-, and z-axes), because the side charging inductor allows the user to align the coils in a single direction (e.g., z-axis).

Coil 112 is configured to produce an energy field which, when the mobile device 102 is positioned within range of the energy field, transfers energy to the coil 106 in the mobile device 102 via induction. As discussed above, induction efficiency may be improved when the coil 106 in the mobile device 102 is substantially aligned with coil 112 in the charging device 110. In one or more embodiments, a DC current moving through coil 112 produces a magnetic field which may be gathered by the coil 106 in the mobile device 102 when the coils 106 and 112 are proximal to one another. Interrupting the DC current causes the magnetic field to collapse which in turn causes a high voltage pulse to be developed in coil 106 of the mobile device 102. By continuously interrupting the DC current, the energy produced by the high voltage pulses are converted into AC current in the coil 106 of the mobile device 102. The mobile device 102 may then use the converted AC current to transfer energy to the battery 104 to charge the battery 104. It should be readily apparent that the illustrated example is but one of a variety of different examples. For instance, the charging device 110 may incorporate a housing such that the side of the mobile device 102 that includes the coil 106 rests against a side of the charging device 110 that includes coil 112, e.g., in a near or substantially vertical position.

Example Procedures

The following discussion describes techniques for implementing a side charging inductor utilizing the previously described systems and devices. Aspects of the procedure may be implemented in hardware, firmware, software, or a combination thereof The procedure is shown as a set of blocks in this example that specify operations performed by one or more devices and are not necessarily limited to the orders shown for performing the operations by the respective blocks. In portions of the following discussion, reference will be made to the environment 100 of FIG. 1 and the implementation 200 of FIG. 2.

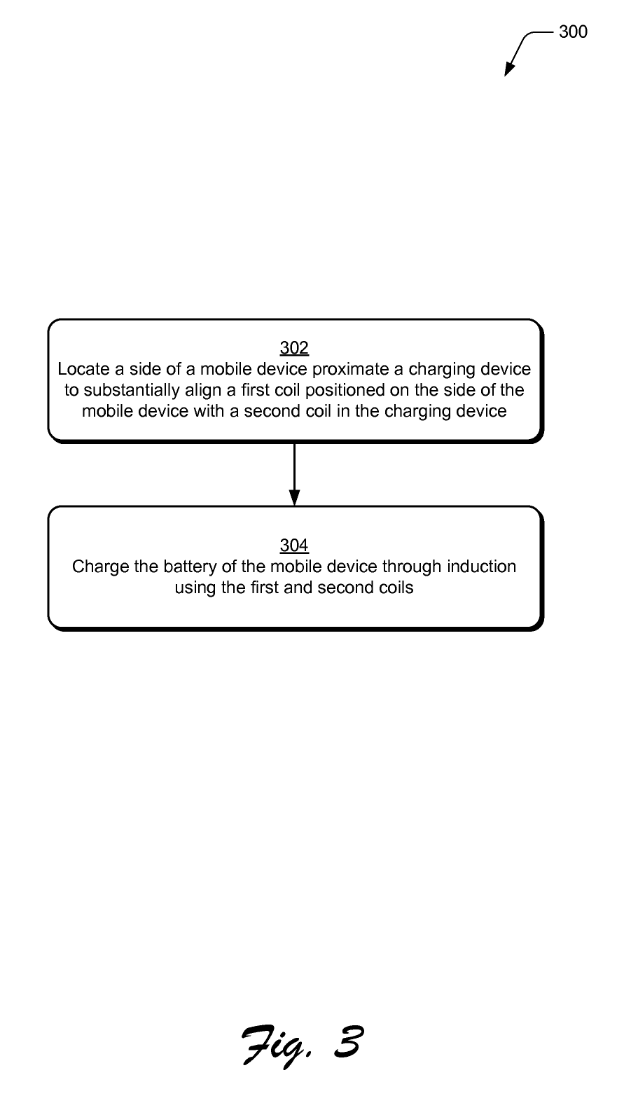

FIG. 3 depicts a procedure 300 in an example implementation in which a side charging inductor may be used to charge a battery of a mobile device. In at least some embodiments, procedure 300 may be performed by a suitably configured mobile device either automatically or in response to a user input.

A side of the mobile device 102 is located proximate to a charging device 110 to substantially align a first coil positioned on the side of the mobile device 102 with a second coil in the charging device 110 (block 302). The first coil may include coil 106 from FIGS. 1 and 2, whereas the second coil may include coil 112 from FIGS. 1 and 2. In addition, the side of the mobile device 102 with the coil may include a side that is substantially perpendicular to a resting side of the mobile device 102.

The resting side may include an exposed face upon which the mobile device 102 is configured to rest on a surface, such as for example, a countertop or table. By resting the mobile device 102 on a surface proximate the charging device 110, at least one direction of alignment (e.g., y-axis referred to in FIG. 2) is automatically aligned, and a distance between coils in a second direction (e.g., x-axis referred to in FIG. 2) is minimized. Accordingly, a single direction of alignment remains for a user to manually align, simplifying the alignment process for the user. In addition, the coil in the side of the mobile device 102 may be electrically coupled to a battery 104 of the mobile device 102. Other implementations are also contemplated, e.g., in which the coil 106 is positioned on a side of the mobile device 102 having an exposed surface that is substantially perpendicular to an exposed surface of a display screen of the mobile device 102.

The battery 104 of the mobile device 102 is charged through induction using the first and second coils (block 304). For example, when the first coil in the side of the mobile device 102 is located proximal to and substantially aligned with the second coil in the charging device 110, energy may be transferred from the second coil to the first coil through induction. The energy may be in the form of a magnetic field which is absorbed by the first coil and converted into an electric current. The first coil may then transfer the current to the battery 104. In this way, the battery 104 of the mobile device 102 may be charged. In addition, because the first coil in the mobile device 102 is disposed on the side of the mobile device 102, the resting side may be formed from a metal without interfering with the induction. In embodiments, the exposed face of the resting side may include a frontplate or backplate that is replaceable without interfering with the induction.

Example Device

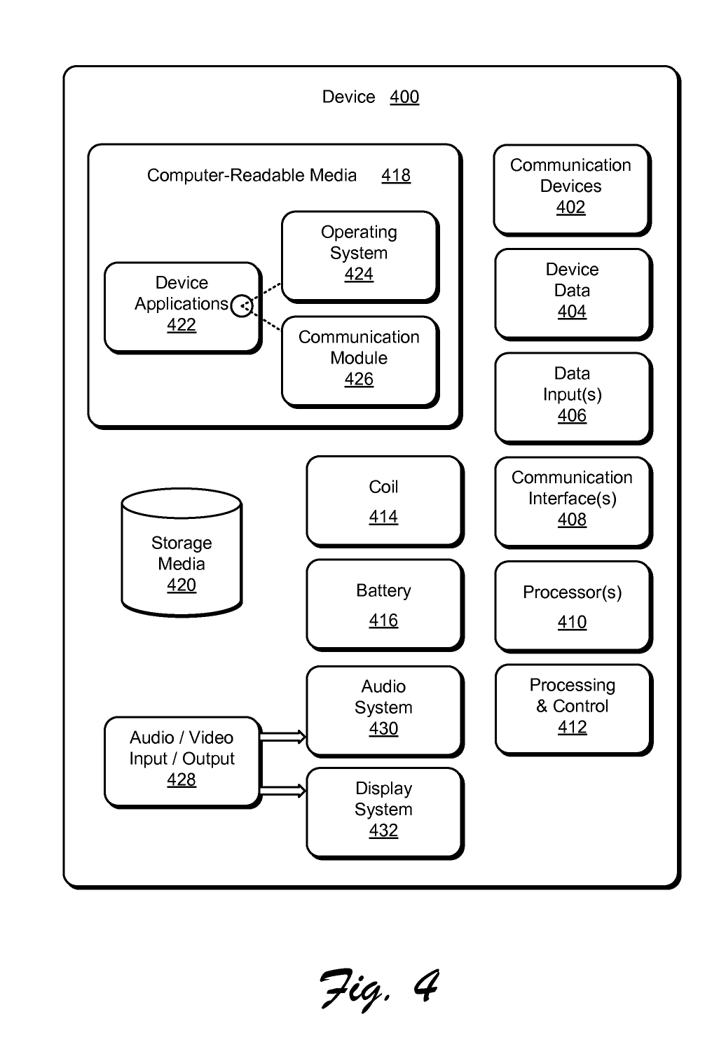

FIG. 4 illustrates various components of an example device 400 that can be implemented as any type of portable and/or computer device as described with reference to FIGS. 1-3 to implement embodiments of the side charging inductor described herein. Device 400 includes communication devices 402 that enable wired and/or wireless communication of device data 404 (e.g., received data, data that is being received, data scheduled for broadcast, data packets of the data, etc.). The device data 404 or other device content can include configuration settings of the device, media content stored on the device, and/or information associated with a user of the device. Media content stored on device 400 can include any type of audio, video, and/or image data. Device 400 includes one or more data inputs 406 via which any type of data, media content, and/or inputs can be received, such as user-selectable inputs, messages, music, television media content, recorded video content, and any other type of audio, video, and/or image data received from any content and/or data source.

Device 400 also includes communication interfaces 408 that can be implemented as any one or more of a serial and/or parallel interface, a wireless interface, any type of network interface, a modem, and as any other type of communication interface. The communication interfaces 408 provide a connection and/or communication links between device 400 and a communication network by which other electronic, computing, and communication devices communicate data with device 400.

Device 400 includes one or more processors 410 (e.g., any of microprocessors, controllers, and the like) which process various computer-executable instructions to control the operation of device 400 and to implement embodiments described herein. Alternatively or in addition, device 400 can be implemented with any one or combination of hardware, firmware, or fixed logic circuitry that is implemented in connection with processing and control circuits which are generally identified at 412. Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 400 also includes coil 414, such as one or more wires capable of conducting an electric current. In embodiments, the current may be a DC current which causes the coil 414 to generate an energy field, such as an electric, magnetic, and electromagnetic field, and the like. Alternatively, the current in the coil 414 may be induced via an energy field that continuously collapses to produce high voltage pulses which generate the current in the coil 414. The current can then be used to charge a battery 416 of the device. The battery 416 provides electricity to power the device 400 and its components. Battery 416 may include a variety of different configurations of rechargeable batteries. Examples of rechargeable batteries include alkaline batteries, lithium-ion batteries, nickel-metal hydride batteries, nickel-cadmium batteries, lithium-ion polymer batteries, and so on.

Device 400 also includes computer-readable media 418, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 400 can also include a mass storage media device 420.

Computer-readable media 418 provides data storage mechanisms to store the device data 404, as well as various device applications 422 and any other types of information and/or data related to operational aspects of device 400. For example, an operating system 424 can be maintained as a computer application with the computer-readable media 418 and executed on processors 410. The device applications 422 can include a device manager (e.g., a control application, software application, signal processing and control module, code that is native to a particular device, a hardware abstraction layer for a particular device, etc.). The device applications 422 also include any system components or modules to implement embodiments of the side charging inductor described herein. In this example, the device applications 422 include a communication module 426 that is shown as a software module and/or a computer application. The communication module 426 is representative of software that is used to communicate to a user that the battery 416 is charging. Alternatively or in addition, the communication module 426 can be implemented as hardware, software, firmware, or any combination thereof.

Device 400 also includes an audio and/or video input-output system 428 that provides audio data to an audio system 430 and/or provides video data to a display system 432. The audio system 430 and/or the display system 432 can include any devices that process, display, and/or otherwise render audio, video, and image data. Video signals and audio signals can be communicated from device 400 to an audio device and/or to a display device via an RF (radio frequency) link, S-video link, composite video link, component video link, DVI (digital video interface), analog audio connection, or other similar communication link. In an embodiment, the audio system 430 and/or the display system 432 are implemented as external components to device 400. Alternatively, the audio system 430 and/or the display system 432 are implemented as integrated components of example device 400.

Conclusion

Although the embodiments above have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A mobile device comprising:
a housing including a first side and a second side that are not substantially parallel to one another;
the first side comprising an exposed face upon which the mobile device is configured to rest on a surface; and
the second side including a coil configured to charge a battery disposed within the housing using induction.

2. The mobile device of claim 1, wherein the first side is substantially parallel to at least one display screen of the mobile device housing.

3. The mobile device of claim 2, wherein first side is formed of a metal.

4. The mobile device of claim 1, wherein the second side is not a resting side upon which the mobile device may rest on a surface.

5. The mobile device of claim 1, wherein the second side includes a smaller exposed area than an exposed area of the first side.

6. The mobile device of claim 1, wherein the battery is configured to be removable from the mobile device.

7. The mobile device of claim 1, wherein the coil is configured to charge the battery when the mobile device is in a resting position and located proximate a charging device.

8. The mobile device of claim 1, further comprising an indicator module configured to, when the battery is charging, indicate to a user of the mobile device that the battery is charging.

9. The mobile device of claim 1, wherein the housing is coupleable to an accessory that is configured to protect the housing and expose the second side for charging.

10. A method comprising:
locating a side of a mobile device proximate a charging device to substantially align a first coil positioned on the side of the mobile device with a second coil in the charging device, the side of the mobile device being substantially perpendicular to a resting side of the mobile device, the resting side being an exposed face upon which the mobile device is configured to rest on a surface, the first coil being electrically coupled to a battery of the mobile device; and
charging the battery of the mobile device through induction using the first and second coils.

11. The method of claim 10, wherein the resting side is formed from a metal.

12. The method of claim 10, wherein the first coil is substantially a same size as a size of the second coil.

13. The method of claim 10, wherein the charging device is configured to charge multiple mobile devices.

14. The method of claim 10, wherein the mobile device comprises a phone.

15. The method of claim 10, wherein the mobile device comprises a game controller.

16. The method of claim 10, wherein the mobile device comprises a mouse.

17. A charging device comprising:
a housing; and
an inductive coil positioned within the housing and configured to induce a current in a coil of a mobile device to charge a battery of the mobile device, the inductive coil positioned within the housing as substantially perpendicular to a plane defined by an outer surface of a display screen of the mobile device when the mobile device is positioned proximal to the housing to enable inductive charging using the coils.

18. The charging device of claim 17, wherein the inductive coil is further configured to induce a current in multiple coils in multiple devices to charge one or more batteries of each of the multiple mobile devices.

19. The charging device of claim 17, wherein the inductive coil is substantially a same size as a size of the coil of the mobile device.

20. The charging device of claim 17, wherein the mobile device comprises a phone.
